(19) United States
(12) Patent Application Publication
(10) Pub. No.: US 2024/0208854 A1
(43) Pub. Date: Jun. 27, 2024

(54) TiO2-CONTAINING SILICA GLASS SUBSTRATE

(71) Applicant: AGC Inc., Tokyo (JP)

(72) Inventors: Tomoki OWADA, Fukushima (JP); Kazuya SASAKI, Fukushima (JP); Masahiro KAWAGISHI, Fukushima (JP); Satoru KURATA, Tokyo (JP)

(73) Assignee: AGC Inc., Tokyo (JP)

(21) Appl. No.: 18/424,963

(22) Filed: Jan. 29, 2024

Related U.S. Application Data
(63) Continuation of application No. PCT/JP2022/033482, filed on Sep. 6, 2022.

(30) Foreign Application Priority Data
Sep. 8, 2021 (JP) 2021-146400

(51) Int. Cl. C03C 3/078; C03C 3/06

(52) U.S. Cl. CPC C03C 3/078; C03C 3/06; C03C 2204/00

(57) ABSTRACT

The present invention relates to a TiO₂-containing silica glass substrate that: contains 6.7-12 mass % of TiO₂, expressed as a mass percentage on an oxide basis; has a CTE-slope of 1.40 ppb/K/K or less; and, in at least one main surface and at least one end surface, (A) no striae are observed in a stria evaluation in compliance with JOGIS 11-2008, or (B) the striation intensity corresponds to class A under US military specification MTL-G-174 B.

### CROSS-REFERENCE TO RELATED APPLICATIONS

This is a continuation of International Application No. PCT/JP2022/033482 filed on Sep. 6, 2022, and claims priority from Japanese Patent Application No. 2021-146400 filed on Sep. 8, 2021, the entire content of which is incorporated herein by reference.

### TECHNICAL FIELD

The present invention relates to a TiO₂-containing silica glass substrate.

### BACKGROUND ART

A TiO₂-containing silica glass is known as an ultra-low thermal expansion material, and by adjusting the content of TiO₂, the coefficient of thermal expansion can be controlled, and the coefficient of thermal expansion can be made almost zero in a specific temperature range, that is, zero expansion can be achieved. Therefore, the TiO₂-containing silica glass is attracting attention as a material suitable for applications where low thermal expansion and smoothness are strictly required, for example, a precision component material such as an optical component material, a large reflector substrate material, or a standard reference for precision measurement, or an exposure device optical material for EUV (extreme ultra violet) lithography.

As a method for producing a TiO₂-containing silica glass, a gas phase method (for example, Patent Literatures 1 and 2) and a liquid phase method (for example, Patent Literature 3) are known.

The gas phase method includes a direct method and an indirect method. The direct method is a production method in which TiO₂-containing silica glass fine particles (soot) obtained by flame hydrolysis or thermal decomposition of a glass raw material are deposited on a base material and are simultaneously vitrified into a transparent glass to obtain a TiO₂-containing silica glass. The indirect method is a production method in which TiO₂-containing silica glass fine particles (soot) obtained by flame hydrolysis or thermal decomposition of a glass raw material are deposited and grown on a base material to obtain a porous TiO₂-containing silica glass, and then the obtained porous TiO₂-containing silica glass is heated to a temperature equal to or higher than a transparent vitrification temperature to obtain a TiO₂-containing silica glass.

The liquid phase method is a production method in which a glass raw material powder is made into a slurry, followed by drying and a heat treatment to vitrify into a transparent glass.

### CITATION LIST

### Patent Literature

Patent Literature 1: JP5367204B
Patent Literature 2: JP4646314B
Patent Literature 3: JP2004-131373A

### SUMMARY OF INVENTION

### Technical Problem

In the gas phase method, a periodic variation (stria) is generated in a TiO₂/SiO₂ composition ratio in the glass due to a thermal history in a production step. In the case where this stria is present, it is difficult to obtain a surface having ultrahigh smoothness even by mirror polishing, making it not preferred for optical applications. Therefore, various methods have been studied for preventing the stria (Patent Literatures 1 and 2).

However, these methods do not fundamentally eliminate the stria, but are only to reduce the stria. In the gas phase method, it is difficult to completely prevent the stria from generating.

On the other hand, in the liquid phase method disclosed in Patent Literature 3, it is considered that the periodic stria on the surface of the glass as described above is prevented as compared to the gas phase method. Here, in order to prevent a change in the shape of a substrate due to a temperature change during use, the rate of change (CTE-Slope) of a coefficient of thermal expansion of the glass is desirably low. For example, when the glass substrate expands in volume at the time of exposure, distortion occurs in an image, which leads to a deterioration of exposure characteristics. However, when a raw material having an average particle diameter as disclosed in Patent Literature 3 is used, it is difficult to control the OH concentration in the glass, and as a result, it is extremely difficult to realize a low CTE-Slope. In addition, the particle diameter of the raw material is highly likely to influence homogeneity of the TiO₂ concentration in the glass.

In this way, it is also difficult to obtain a homogeneous glass in the liquid phase method, and there is room for improvement in completely preventing the generation of the stria.

In addition, the stria is not necessarily present in parallel with the main surface, and may be also present in an end surface direction.

In view of the above, an object of the present invention is to provide a TiO₂-containing silica glass substrate in which the CTE-Slope is low, and no stria is present on any surface including not only a main surface but also an end surface.

### Solution to Problem

A silica glass substrate according to the present invention for solving the above problems is as follows.

[1] A TiO₂-containing silica glass substrate, containing 6.7 mass % to 12 mass % of TiO₂ expressed as a mass percentage in terms of an oxide, and having a CTE-slope of 1.40 ppb/K/K or less, in which no stria is observed on at least one main surface and on at least one end surface in a stria evaluation according to JOGIS-11 (2008).

[2] A TiO₂-containing silica glass substrate, containing 6.7 mass % to 12 mass % of TiO₂ expressed as a mass percentage in terms of an oxide, and having a CTE-slope of 1.40 ppb/K/K or less, in which stria strengths on at least one main surface and on at least one end surface conform to class A of MIL-G174B in United States Military Standard.

### Advantageous Effects of Invention

In the TiO₂-containing silica glass substrate according to the present invention, the CTE-Slope is low, and no stria is observed on any surface including not only the main surface but also the end surface. Therefore, the TiO₂-containing silica glass substrate according to the present invention has small thermal expansion, and a surface having ultrahigh smoothness can be easily obtained by mirror polishing.

### BRIEF DESCRIPTION OF DRAWINGS

FIG. 1 shows a stria evaluation result of a standard sample according to JOGIS.

FIG. 2 shows a stria evaluation result of Example 1 in an end surface direction according to JOGIS.

FIG. 3 shows a stria evaluation result of Example 3 in the end surface direction according to JOGIS.

FIG. 4 shows a class evaluation result of a standard sample according to United States Military Standard.

FIG. 5 shows a class evaluation result of Example 1 in the end surface direction according to United States Military Standard.

FIG. 6 shows a class evaluation result of Example 3 in the end surface direction according to United States Military Standard.

### DESCRIPTION OF EMBODIMENTS

Hereinafter, embodiments of the present invention will be described in detail. Note that the present invention is not limited to the following embodiments.

A silica glass substrate according to the present embodiment (hereinafter, also simply referred to as a “glass substrate according to the present embodiment”) is a silica glass substrate having a content of TiO₂ of 6.7 mass % to 12 mass % expressed as a mass percentage in terms of an oxide, and having a CTE-slope of 1.40 ppb/K/K or less, in which no stria is observed on at least one main surface and on at least one end surface in stria evaluation according to JOGIS-11 (2008).

In addition, the silica glass substrate according to the present embodiment is a silica glass substrate having a content of TiO₂ of 6.7 mass % to 12 mass % expressed as a mass percentage in terms of an oxide, having a CTE-slope of 1.40 ppb/K/K or less, wherein at least one main surface and at least one end surface conform to class A of MIL-G174B.

Hereinafter, the glass substrate will be described in detail.

In the case where the content of TiO₂ in the glass substrate according to the present embodiment is too large, a coefficient of thermal expansion may be too large. In the case where it is too small, the coefficient of thermal expansion may be negative. In either case, there is a risk that zero expansion cannot be achieved.

Therefore, the content of TiO₂ in the glass substrate according to the present embodiment is 6.7 mass % or more, preferably 7.0 mass % or more, and more preferably 7.5 mass % or more, and is 12 mass % or less, preferably 11 mass % or less, and more preferably 10 mass % or less.

The remainder of the glass substrate according to the present embodiment is mainly composed of SiO₂. The content of SiO₂ in the glass substrate according to the present embodiment is, for example, 88 mass % or more, preferably 89 mass % or more, and more preferably 90 mass % or more, and is, for example, 93.3 mass % or less, preferably 93 mass % or less, and more preferably 92.5 mass % or less.

In addition, the glass substrate according to the present embodiment may contain a component other than SiO₂ and TiO₂ as long as the effect of the present invention is not impaired. For example, the glass substrate according to the present embodiment may contain oxides of Ce, B, P, Ge, and Zr, and the like.

The glass substrate according to the present embodiment preferably has a concentration distribution of TiO₂ of 0.1 mass % or less. In the case where the concentration distribution of TiO₂ in the substrate is within such a range, stable thermal expansion characteristics can be obtained.

Note that the concentration distribution of TiO₂ in the glass substrate can be measured by fluorescent X-rays.

The glass substrate according to the present embodiment preferably has an OH group concentration of 600 ppm by mass or more. In the case where the OH group concentration in the glass substrate is 600 ppm by mass or more, the slope of the CTE-slope can be reduced. The OH group concentration is more preferably 700 ppm by mass or more, and still more preferably 800 ppm by mass or more. In addition, in the case where the OH group concentration is 1200 ppm by mass or less, an influence on glass hardness is small, and it is difficult to lead to an increase in defect during polishing. The OH group concentration is preferably 1100 ppm by mass or less, and more preferably 1000 ppm by mass or less.

The OH concentration in the glass substrate greatly depends on a particle diameter of raw material silica. This is considered to be caused by an isolated silanol group present on the surface of the raw material silica, and it is considered that the smaller the size of the particle diameter of the raw material, the higher the sintering rate, and as a result, the removal of the silanol group is prevented. Therefore, it has been confirmed that the larger the specific surface area of the raw material, the higher the OH concentration in the glass substrate. By using a raw material having a BET particle diameter of the raw material of less than 30 nm, the OH concentration in the glass substrate can be achieved 600 ppm by mass or more. Although it is possible to increase the OH concentration in the glass substrate by reducing the particle diameter of the raw material, it is extremely difficult to increase a solid content concentration in a liquid when it is made into a slurry. As a result, it is unsuitable for production methods such as a sol-gel method in which gelling is performed by adding a gelling agent.

The OH concentration can be measured by a known method. For example, the measurement can be performed by using an infrared spectrophotometer, and the OH concentration can be obtained based on an absorption peak at a wavelength of 2.7 μm (J. P. Williams et. al., American Ceramic Society Bulletin, 55(5), 524, 1976).

The glass substrate according to the present embodiment has a CTE-slope of 1.40 ppb/K/K or less. The CTE-slope means a slope of CTE at a temperature (COT) at which the coefficient of thermal expansion (CTE) is 0 ppb/K. A smaller CTE-slope is preferred since the thermal expansion characteristics are good. The glass substrate according to the present embodiment preferably has a CTE-slope of 1.30 ppb/K/K or less. In addition, in order to achieve the CTE-slope of 1.40 ppb/K/K or less, the OH concentration in the glass substrate is preferably 600 ppm or more.

The CTE-slope can be measured by an interference thermal expansion meter.

In the glass substrate according to the present embodiment, no stria is observed on at least one main surface and on at least one end surface in stria evaluation according to the Japan Optical Glass Manufacturers' Association standard JOGIS-11 (2008). The glass substrate according to the present embodiment has no stria observed not only on at least one main surface but also on at least one end surface, that is, it is a highly homogeneous glass substrate.

Note that the expression “no stria is observed” means that no shadow caused by a stria is observed in an environment in which a shadow of a step of 10 nm projected on a screen can be observed.

The stria evaluation is performed according to JOGIS-11 (2008). A measurement sample is provided between a projection device and a screen and projected on the screen to observe and evaluate the stria. Note that an illuminance on the screen is ensured to be 50 lux or more. In addition, in the measurement, the illuminance on the screen is adjusted by a stria standard sample. The stria standard sample can be prepared by using methods such as vapor deposition or etching. A projected image of the measurement sample is compared with a projected image of the stria standard sample, and a degree of stria is evaluated.

In the glass substrate according to the present embodiment, stria strengths on at least one main surface and on at least one end surface conform to class A of MIL-G174B in United States Military Standard. Similar to the above, this means that the glass substrate according to the present embodiment has no stria observed not only on at least one main surface but also on at least one end surface, that is, it is a highly homogeneous glass substrate.

In the stria evaluation based on MIL-G174B in United States Military Standard, a measurement sample is irradiated with parallel light from a monochromatic light source through a collimating lens, and a shadow of the stria of the measurement sample is compared with a shadow of a stria standard sample to perform evaluation. The stria standard sample can be prepared by using methods such as vapor deposition or etching.

Examples of a method for obtaining the above-described glass substrate in which no stria is observed on either the main surface or the end surface includes a liquid phase method represented by a sol-gel method in the production method to be described later, and zone melting in which a part of the glass obtained by a gas phase method is heated and subjected to a homogenization treatment while shearing is applied. However, it is considered that the zone melting is effective as a method for reducing the stria, but it is considered that it is very difficult to completely remove the stria within a realistic production time range.

The glass substrate according to the present embodiment preferably has an in-plane refractive index variation width Δn of 5×10⁻⁵ or less on at least one main surface and on at least one end surface.

Here, the refractive index corresponds to a deviation of the TiO₂/SiO₂ composition ratio. In the TiO₂-containing silica glass substrate, in the case where the deviation of the TiO₂/SiO₂ composition ratio is large, it is very difficult to obtain ultrahigh smoothness by mirror polishing. This is because, in the TiO₂-containing silica glass substrate, the mechanical and chemical properties of the glass are different depending on the composition ratio in a portion where the TiO₂/SiO₂ composition ratio is different, and therefore a polishing rate is not constant. In the case where the TiO₂/SiO₂ composition ratio is different, the refractive index is also different. Therefore, the deviation of the TiO₂/SiO₂ composition ratio can be evaluated by using the refractive index. The glass substrate according to the present embodiment is homogeneous, and therefore, even when measurement is performed from either the main surface side or the end surface side, the in-plane refractive index variation is small.

The in-plane refractive index variation width Δn is preferably 5×10⁻⁵ or less. The glass substrate according to the present embodiment is a homogeneous glass in which the refractive index variation width Δn is small on both the main surface side and the end surface side, that is, the deviation of the TiO₂/SiO₂ composition ratio is small. Therefore, it is possible to easily obtain ultrahigh smoothness by mirror polishing.

The refractive index variation width (Δn) means a refractive index variation width measured on a measurement surface of a measurement sample. The measurement sample is cut out from a glass substrate and has the measurement surface having a predetermined area. Note that the measurement sample is cut out such that the measurement surface of the measurement sample is parallel to the surface to be measured for Δn. That is, when Δn of the main surface of the glass substrate is measured, a measurement sample having a measurement surface parallel to the main surface is cut out and the measurement is performed. When Δn of the end surface of the glass substrate is measured, a measurement sample having a measurement surface parallel to the end surface is cut out and the measurement is performed.

The size of the measurement sample is not particularly limited, and the size is set such that a measurement region large enough to detect a variation in refractive index can be ensured in the measurement surface.

A method for measuring the refractive index variation width Δn is different in a case of a refractive index variation width Δni in a small region and in a case of a refractive index variation width Δn₂ in a wide range as described below.

The refractive index variation width Δni in the small region is measured as follows.

A measurement sample having a size capable of ensuring a measurement region (for example, a measurement region of 3 mm×3 mm) large enough to detect a variation in refractive index in a small region on a measurement surface (for example, a measurement sample of 6 mm×30 mm×1 mm) is cut out from the glass substrate. In a Fizeau interferometer, a helium neon laser beam is perpendicularly applied to a measurement region (for example, a measurement region of 3 mm×3 mm) on the measurement surface of the measurement sample, an in-plane refractive index distribution is examined, and the refractive index variation width Δn₁, that is, a difference between a maximum value and a minimum value of the in-plane refractive index, is obtained.

Note that, depending on the number of effective pixels of a CCD of the interferometer, there is a possibility that the size of one pixel is not sufficiently smaller than the width of the stria, and there is a possibility that the stria cannot be detected. In this case, the measurement region is divided into a plurality of minute regions, a refractive index variation width Δn₁ₓ of each minute region is measured, and the maximum value is set as the refractive index variation width Δn₁.

The refractive index variation width Δn₂ in a wide range, such as a surface (main surface) irradiated with EUV light used for exposure, is measured in the same manner by cutting out, from a glass substrate, a measurement sample having a size capable of ensuring a measurement region (for example, a measurement region of 100 mm×100 mm) large enough to detect a variation in refractive index in a wide range.

Note that when Δn₁ measured on the same surface is larger than Δn₂, Δn₁ is set to Δn, and when Δn₂ is equal to or larger than Δn₁, Δn₂ is set to Δn.

The content of TiO₂ can be measured by an electron beam microanalyzer (EPMA) or the like, and the refractive index can be obtained according to the following equation (A). The following equation (A) is established when the content of TiO₂ is 12 mass % or less in the TiO₂-containing silica glass.

Refractive index=3.27×10⁻³×content of TiO₂(mass %)+1.459 (A)

The thickness and the dimension of the main surface of the glass substrate according to the present embodiment are not particularly limited. For example, it is preferable that each side forming the main surface has a length of 150 mm or more, and the thickness is 6.0 mm or more.

The glass substrate according to the present embodiment preferably does not contain air bubbles of 10 μm or more. Air bubbles of 10 μm or more influence flatness during polishing, and thus are preferably not contained.

Examples of a method for not containing air bubbles of 10 μm or more include using a slurry having a sharp particle size distribution not containing coarse particles. It is confirmed that coarse particles in the slurry form a heterogeneous layer when forming a wet cake and remain as bubbles after densification.

In a glass substrate having a stria, even when mirror polishing is performed, waviness having a pitch equal to a stria pitch is generated on the surface. Therefore, it is very difficult to obtain such small smoothness as described above. On the other hand, since the glass according to the present embodiment is homogeneous, it is possible to easily obtain the small smoothness as described above by mirror polishing.

The smoothness on the main surface of the glass substrate can be measured by, for example, a non-contact surface shape measuring instrument (New View 5032 manufactured by Zygo Corporation).

### Method for Producing Silica Glass Substrate

Next, a production method according to a liquid phase method (sol-gel method) will be described as an example of a method for producing the glass substrate according to the present embodiment. Note that the method for producing the glass substrate according to the present embodiment is not limited to the production method described below.

The method for producing the TiO₂-containing silica glass according to the present embodiment by using a liquid phase method (hereinafter, also referred to as “the present production method”) includes the following steps (1) to (5).
(1) Slurry production step
(2) Dispersion step
(3) Dehydration filtration step
(4) Drying step
(5) Heat treatment step

Note that the present production method may include steps other than the above (1) to (5). For example, a step of processing to a desired dimension or a mirror polishing step may be provided after the heat treatment step.

### <Slurry Production Step>

The slurry production step is a step of producing a raw material slurry in which a raw material powder is dispersed as primary particles in a dispersion medium.

As the raw material powder, a silica powder and a titania powder are used, which are mixed so as to have a desired TiO₂/SiO₂ composition ratio. In the case of using water as a dispersion medium, it is preferable to use a titania-containing silica powder as the titania powder from the viewpoint of preventing coagulation and precipitation of titanium.

In order to obtain a uniform glass, the BET diameter of the raw material powder (that is, the silica powder and the titania powder) is preferably small, and is preferably, for example, 150 nm or less, more preferably 100 nm or less, still more preferably 40 nm or less, and particularly preferably 30 nm or less. On the other hand, in the case where the particle diameter of the raw material is too small, a decrease in solid content concentration in the slurry, an increase in filtration resistance in the dehydration filtration, and the like occur, resulting in a remarkable decrease in productivity. Therefore, the raw material powder preferably has a BET diameter of 10 nm or more.

The dispersion medium is not particularly limited, and for example, water can be used.

In addition, additives such as a pH adjuster, a surfactant, a dispersant, and a binder may be added to the raw material slurry as appropriate.

The raw material powder and the additive are dispersed in the dispersion medium to obtain a raw material slurry. Here, by using a slurry having a sharp particle size distribution and containing no coarse particles, a glass substrate not containing air bubbles after densification can be obtained.

In order to obtain a slurry containing no coarse particles, coarse particles are preferably removed if necessary. Examples of a method for removing coarse particles include a method of filtering the slurry by using a filter having a desired opening.

In addition, from the viewpoint of preventing bubbles and internal defects, it is preferable to perform precise dispersion during the dispersion. The coarse particles mean silica agglomerates of about 1 μm. By selecting an appropriate filter, coarse particles of 1 μm or more can be removed. A disperser used for the precise dispersion is not particularly limited, and examples thereof include a wet jet mill, a ball mill, and a bead mill.

### <Dehydration Filtration Step>

In the dehydration filtration step, solid-liquid separation is performed on the raw material slurry by dehydration filtration to obtain a wet cake. In the dehydration filtration step, the wet cake (gel) is formed by depositing the slurry homogeneously dispersed in the nano-order while maintaining the dispersion state. Here, the homogeneity of the wet cake is originated from the dispersibility of the slurry. In the related art, a method of obtaining a wet cake by adding a gelling agent to a raw material slurry to cause precipitation has been known. In such a method, secondary particles and tertiary particles are likely to be formed in the slurry. It is considered that the dispersibility of the slurry is likely to decrease, and it is also considered that the homogeneity of the obtained wet cake is low.

In the present invention, a method for the dehydration filtration is not particularly limited, and any appropriate method can be selected. Either reduced pressure filtration or pressure filtration can be used. In the reduced pressure filtration, a device structure is simple, but a filtration rate is slow. In the pressure filtration, a device structure is complicated due to the use of a pressurized container, but it is possible to increase a back pressure, contributing to a high filtration rate and high productivity.

From the viewpoint of productivity, it is preferable to perform pressure filtration. A wet cake can also be formed in the reduced pressure filtration, but the deposition rate is slow, so that the pressure filtration is preferred for preparing a large size.

In particular, in the case where the size of the glass substrate is large, when the removal of the dispersion medium in the dehydration filtration step is insufficient, the glass substrate may be cracked or may shrink in the drying step or the heat treatment step. In order to prevent such a problem, a method such as removal of a solvent by filtering is exemplified. An example of the method of removing a solvent by filtering includes filling a pressurized container with the slurry and performing solid-liquid separation by using a membrane filter. The back pressure can be freely selected. The higher the back pressure, the higher the filtration rate, but desorption from the membrane filter tends to increase. An opening of the membrane filter can be determined according to the dispersion state of the slurry.

### <Drying Step>

In the drying step, the wet cake is dried to obtain a dried body. The drying method is not particularly limited, and an appropriate method can be used.

For example, a dried body can be obtained in a constant temperature and constant humidity environment of 30° C. and 60 rh % over about 30 days.

### <Heat Treatment Step>

In the heat treatment step, the dried body is subjected to a heat treatment. In the heat treatment step, for example, the following heat treatment is preferably performed.

### (Atmospheric Firing)

First, the dried body is subjected to atmospheric firing to burn out organic substances (binder or the like) contained in the dried body. The heating temperature and the heating time in the atmospheric firing are not particularly limited as long as they are the temperature and the time at which the contained organic substances are burnt out. The heating temperature is, for example, 100° C. to 800° C., and the heating time is, for example, about 1 hour to 100 hours.

### (Vacuum Firing)

Next, the dried body in which the organic substances are burnt out is subjected to a heat treatment in a vacuum atmosphere to vitrify into a glass. The heating temperature and the heating time in the vacuum firing are not particularly limited as long as they are the temperature and the time at which vitrification progresses, and the heating temperature is, for example, 1,250° C. to 1,300° C., and the heating time is, for example, about 1 hour to 100 hours.

### (High-Temperature Firing)

Next, a heat treatment is further performed at a high temperature to melt a titania crystal in the glass to obtain a uniform glass. The heating temperature and the heating time of the high-temperature firing are not particularly limited as long as they are the temperature and the time at which the titania crystal is sufficiently melt. The heating temperature is, for example, 1,500° C. to 1,700° C., and the heating time is, for example, about 1 hour to 100 hours.

As described above, the present description discloses the following TiO₂-containing silica glass substrate.

[1] A TiO₂-containing silica glass substrate, containing 6.7 mass % to 12 mass % of TiO₂ expressed as a mass percentage in terms of an oxide, and having a CTE-slope of 1.40 ppb/K/K or less, in which no stria is observed on at least one main surface and on at least one end surface in a stria evaluation according to JOGIS-11 (2008).

[2] A TiO₂-containing silica glass substrate, containing 6.7 mass % to 12 mass % of TiO₂ expressed as a mass percentage in terms of an oxide, and having a CTE-slope of 1.40 ppb/K/K or less, in which stria strengths on at least one main surface and on at least one end surface conform to class A of MIL-G174B in United States Military Standard.

[3] The TiO₂-containing silica glass substrate according to [1] or [2], in which an in-plane refractive index variation width Δn is 5×10⁵ or less on the at least one main surface and on the at least one end surface.

[4] The TiO₂-containing silica glass substrate according to any one of [1] to [3], having a concentration distribution of the TiO₂ being 0.1 mass % or less.

[5] The TiO₂-containing silica glass substrate according to any one of [1] to [4], having a OH group concentration of 600 ppm by mass or more.

[6] The TiO₂-containing silica glass substrate according to any one of [1] to [5], having a length of each side forming the main surface being 150 mm or more, and a thickness being 6.0 mm or more.

[7] The TiO₂-containing silica glass substrate according to any one of [1] to [6], being free from air bubbles of 10 μm or more.

### EXAMPLES

Hereinafter, the present invention will be specifically described with reference to Examples, but the present invention is not limited thereto.

### Production of TiO₂-Containing Silica Glass Substrate

### Example 1

### (Slurry Production Step)

A commercially available fumed silica powder (BET diameter: 30 nm) (30,000 g) and a commercially available titania-containing silica powder (BET diameter: 30 nm) (3,500 g) were mixed, and further, 6,500 g of a dispersant (TEAH) and 120,000 g of pure water were mixed to produce a raw material slurry.

### (Dispersion Step)

The obtained slurry was subjected to coarse dispersion using an ultrasonic homogenizer, followed by a dispersion treatment with a wet jet mill, and coarse particles were removed by using a filter having an opening of 1 μm.

### (Dehydration Filtration Step)

The raw material slurry after the dispersion step was subjected to dehydration filtration under the following conditions to obtain a wet cake.

### Device: Pressure Filtration Machine

The raw material slurry was subjected to dehydration filtration to obtain a wet cake. The dehydration filtration was performed by pumping the slurry pressurized to 0.8 MPa into a filter chamber having an internal dimension of 230 in diameter×30, and a wet cake of 230 in diameter×23 mm was obtained.

### (Drying Step)

The obtained wet cake was shaped into a plate shape of 230 mm in diameter×23 mm, and dried for 720 hours in an environment of 30° C. and 60% RH.

### (Heat Treatment Step)

Firing was performed at 600° C. for 10 hours in the atmosphere to remove the dispersant and the binder. Further, firing was performed at 1,280° C. for 2 hours in a vacuum atmosphere to perform vitrification. Then, a heat treatment was performed at 1,600° C. for 10 hours in an argon atmosphere to melt the titania crystal, thereby obtaining a glass substrate.

### Example 2

A glass substrate in Example 2 was obtained in the same manner as in Example 1 except that a commercially available fumed silica powder having a BET diameter of 40 nm was used as the fumed silica powder.

### Example 3

A commercially available silica-titania-doped low expansion glass material was used as a glass substrate in Example 3.

### Example 4

A glass substrate in Example 4 was obtained in the same manner as in Example 1, except that in the dispersion step, a slurry subjected to only coarse dispersion using an ultrasonic homogenizer was used without performing a precise dispersion treatment using a wet jet mill.

The glass substrate in each Example was evaluated as follows.

The results are shown in the table below.

Note that Examples 1 and 4 are Examples, and Examples 2 and 3 are Comparative Examples.

### <Concentration Distribution of TiO₂>

The concentration distribution of TiO₂ was measured at 9×9=81 points in in-plane by using a fluorescent X-ray measurement device (primus 400) manufactured by Rigaku Corporation to calculate a PV value.

### <OH Group Concentration>

Evaluation was performed by using an FT-IR device.

### <CTE-Slope>

A measurement sample having a cross section of 35 mm×10 mm and a length of 100 mm was cut out from each glass substrate, and the CTE in a longitudinal direction thereof was precisely measured in a range of −150° C. to +200° C. by using a laser heterodyne interferometric dilatometer. Then, the value of CTE-Slope was calculated based on the measurement result.

### <Refractive Index Variation Width>

Measurement samples each of 6 mm×30 mm×1 mm were cut out from each glass substrate, one for the main surface and one for the end surface. Note that the measurement samples were cut out such that the surface of 6 mm×30 mm (measurement surface) was parallel to the main surface or the end surface. In the range of 3 mm×3 mm on the measurement surface of the measurement sample, the in-plane refractive index variation width (Δn) was measured by using a two-beam interferometer (transmission type two-beam interference microscope (TD series), manufactured by MIZOJIRI OPTICAL CO., LTD.).

### <Presence or Absence of Air Bubbles of 10 μm or More>

The bubbles were evaluated by visual inspection.

### <Stria Evaluation>

The stria evaluation on the main surface and the end surface of each glass substrate was performed according to JOGIS-11 2008.

After confirming that a shadow was generated when irradiating the screen by using a stria standard sample having an optical path difference of 6 nm, the main surface and the end surface of the glass substrate were evaluated. When the shadow was projected on the screen, it was evaluated that the stria was present, and when no shadow was projected, it was evaluated that no stria was present. Note that, as the standard sample, a sample having a spike-shaped refractive index difference was prepared by using a gas phase method by varying the raw material to be charged during a hydrolysis reaction.

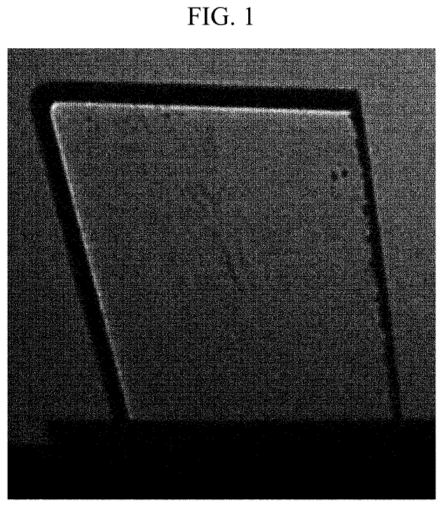

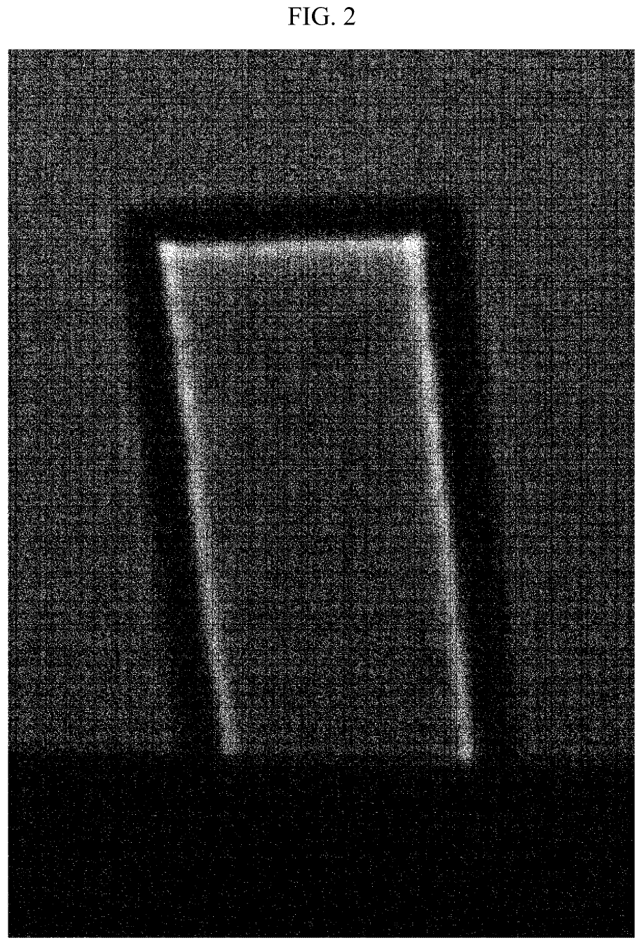

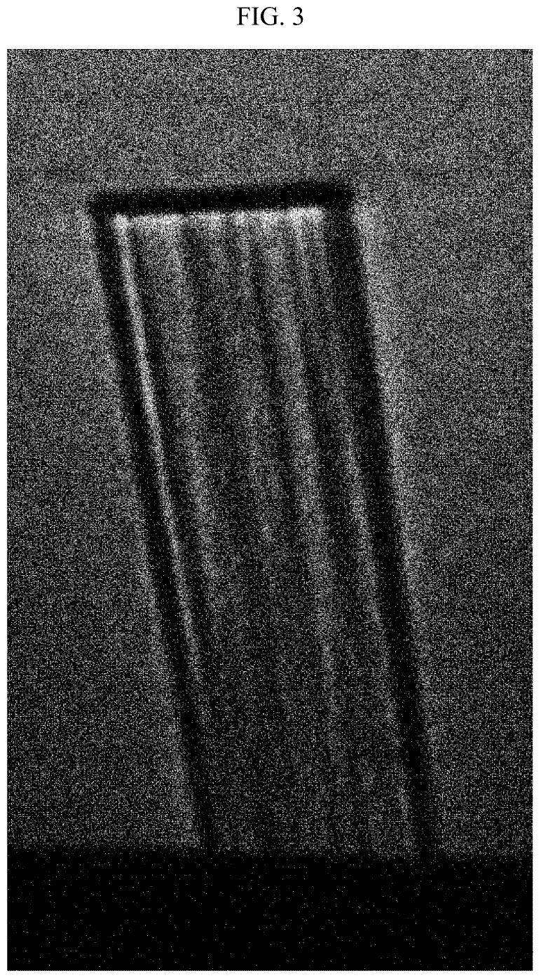

FIG. 1 shows the stria evaluation result of the standard sample in the end surface direction, FIG. 2 shows the stria evaluation result of Example 1 in the end surface direction, and FIG. 3 shows the stria evaluation result of Example 3 in the end surface direction.

### <Class Evaluation According to MIL-G174B>

A stria standard sample having an optical path difference of 10 nm was prepared in the same manner as in the stria evaluation according to JOGIS, and class evaluation on the main surface and the end surface was performed.

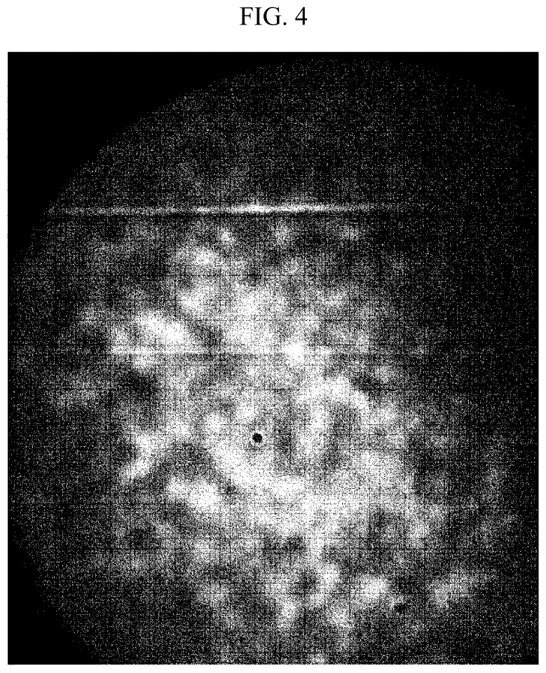

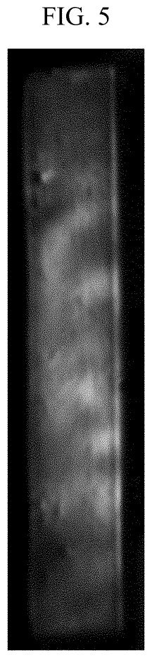

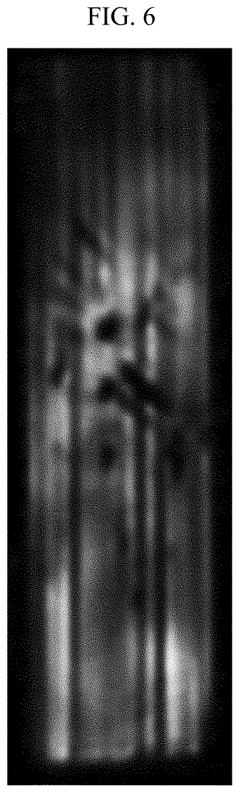

FIG. 4 shows the class evaluation of the standard sample in the end surface direction, FIG. 5 shows the class evaluation of Example 1 in the end surface direction, and FIG. 6 shows the class evaluation of Example 3 in the end surface direction.

### [Table 1]

TABLE 1

| | | Example 1 | Example 2 | Example 3 | Example 4 |
|---|---|---|---|---|---|
| TiO₂ Content (mass %) | | 7.8 | 7.8 | 7.9 | 7.8 |
| TiO₂ Concentration distribution (mass %) | | 0.005 | 0.01 | 0.10 | 0.10 |
| OH group concentration (ppm by mass) | | 800 | 250 | 870 | 800 |
| CTE-Slope (ppb/K/K) | | 1.20 | 1.43 | 1.23 | 1.20 |
| Refractive index | Main surface | 5 ppm or | 5 ppm or | 5 ppm or | 5 ppm or |
| variation width Δn | | less | less | less | less |
| | End surface | 5 ppm or | 5 ppm or | 40 ppm | 5 ppm or |
| | | less | less | | less |
| Presence or absence of air bubbles of 10 | | No | No | No | Yes |
| μm or more | | | | | |
| Striae evaluation | Main surface | No | No | No | No |
| according to JOGIS | End surface | No | No | Yes | No |
| Class of MIL-G174B in | Main surface | Class A | Class A | Class A | Class A |
| US Military Standard | End surface | Class A | Class A | Class C | Class A |

As seen from the above results, the glass substrates in Example 1 and Example 4 had no stria observed on the main surface and the end surface in both evaluations according to JOGIS and according to United States Military Standard, and had a sufficiently low CTE-Slope. In the glass substrate in Example 1, no air bubbles of 10 μm or more were observed, and a homogeneous glass was obtained.

In the glass substrate in Example 2, the CTE-Slope was high, and in the glass substrate in Example 3, the stria was observed on the end surface. Regarding the glass substrate in Example 4, results similar to those in Example 1 were obtained regarding the stria, but it was confirmed that a plurality of air bubbles remained within the substrate.

Although the present invention has been described in detail with reference to specific embodiments, it is obvious to those skilled in the art that various changes and modifications can be made without departing from the spirit and scope of the present invention.

1. A TiO₂-containing silica glass substrate,
comprising 6.7 mass % to 12 mass % of TiO₂ expressed as a mass percentage in terms of an oxide, and
having a CTE-slope of 1.40 ppb/K/K or less, wherein
no stria is observed on at least one main surface and on at least one end surface in a stria evaluation according to JOGIS-11 (2008).

2. A TiO₂-containing silica glass substrate,
comprising 6.7 mass % to 12 mass % of TiO₂ expressed as a mass percentage in terms of an oxide, and
having a CTE-slope of 1.40 ppb/K/K or less, wherein
stria strengths on at least one main surface and on at least one end surface conform to class A of MIL-G174B in United States Military Standard.

3. The TiO₂-containing silica glass substrate according to claim 1, wherein an in-plane refractive index variation width Δn is 5×10⁻⁵ or less on the at least one main surface and on the at least one end surface.

4. The TiO₂-containing silica glass substrate according to claim 1, having a concentration distribution of the TiO₂ being 0.1 mass % or less.

5. The TiO₂-containing silica glass substrate according to claim 1, having a OH group concentration of 600 ppm by mass or more.

6. The TiO₂-containing silica glass substrate according to claim 1, having a length of each side forming the main surface being 150 mm or more, and a thickness being 6.0 mm or more.

7. The TiO₂-containing silica glass substrate according to claim 1, being free from air bubbles of 10 μm or more.

8. The TiO₂-containing silica glass substrate according to claim 2, wherein an in-plane refractive index variation width Δn is 5×10⁻⁵ or less on the at least one main surface and on the at least one end surface.

9. The TiO₂-containing silica glass substrate according to claim 2, having a concentration distribution of the TiO₂ being 0.1 mass % or less.

10. The TiO₂-containing silica glass substrate according to claim 2, having a OH group concentration of 600 ppm by mass or more.

11. The TiO₂-containing silica glass substrate according to claim 2, having a length of each side forming the main surface being 150 mm or more, and a thickness being 6.0 mm or more.

12. The TiO₂-containing silica glass substrate according to claim 2, being free from air bubbles of 10 μm or more.
